(19) United States
(12) Patent Application Publication
(10) Pub. No.: US 2022/0241916 A1
(43) Pub. Date: Aug. 4, 2022

(54) MAGNET HOLDER AND A MAGNETIC DRILL COMPRISING IT

(71) Applicant: HOSAN TECHNOLOGIES CO., LTD., Hwaseong-si (KR)

(72) Inventor: No-Soo SONG, Seoul (KR)

(21) Appl. No.: 17/325,739

(22) Filed: May 20, 2021

Related U.S. Application Data
(63) Continuation of application No. PCT/KR2021/005394, filed on Apr. 28, 2021.

(30) Foreign Application Priority Data
Feb. 2, 2021 (KR) PCT/KR2021/001366

(51) Int. Cl. B23Q 3/154; B25H 1/00

(52) U.S. Cl. CPC B23Q 3/1546; B25H 1/0071

(57) ABSTRACT

Provided is a magnetic holder which may be easily moved even after being released. The magnetic holder includes a fixed permanent magnet extending in one direction, a rotating permanent magnet extending in the one direction and rotatably fixed at both ends, first and second yokes covering both sides of the fixed permanent magnet and the rotating permanent magnet and extending in an up-down direction, and a coil wound around the first and second yokes, wherein, in a cross-section perpendicular to the one direction, the first yoke is in contact with an N pole of the fixed permanent magnet and the second yoke is in contact with an S pole of the fixed permanent magnet, and the coil, the rotating permanent magnet, and the fixed permanent magnet are arranged successively along the first and second yokes from an attachment surface of the first and second yokes attached to the attachment object.

### TECHNICAL FIELD

The present disclosure relates to a magnetic holder and a magnetic drill including the same.

### BACKGROUND ART

Magnetic holders, devices for attaching an attachment object formed of a magnetic material using magnetic force, have been used in various holding devices, machine tools, and the like.

Such a magnetic holder basically attaches an attachment object, a magnetic material, using strong magnetic force of a permanent magnet, and the attachment object may be attached when a magnetic flow is formed thereon and is released when no magnetic flow is formed.

Patent document 1 discloses a magnetic drill to which such a magnetic holder is applied. The magnetic drill including a magnetic holder as in Patent document 1 is a passive type magnetic drill which advantageously eliminates the necessity to use power to fix the drill, but is inconvenient to use, and in particular, even when the magnetic drill is released, the magnetic drill may not be readily detached from an attachment object without force application due to residual magnetization.

### Patent Document 1

U.S. Pat. No. 9,452,521 B2(Published on Sep. 27, 2016)

### DISCLOSURE

### Technical Problem

An aspect of the present disclosure may provide a magnetic holder which is easily fastened and released and which is easily moved when released, and a magnetic drill including the magnetic holder.

### Technical Solution

According to an aspect of the present disclosure, a magnetic holder and a portable magnetic drill are provided as follows.

A magnetic holder includes: a fixed permanent magnet extending in one direction; a rotating permanent magnet extending in the one direction and rotatably fixed at both ends; first and second yokes covering both sides of the fixed permanent magnet and the rotating permanent magnet and extending in an up-down direction; and a coil wound around the first and second yokes, wherein, in a cross-section perpendicular to the one direction, the first yoke is in contact with an N pole of the fixed permanent magnet and the second yoke is in contact with an S pole of the fixed permanent magnet, and the coil, the rotating permanent magnet, and the fixed permanent magnet are arranged successively along the first and second yokes from an attachment surface of the first and second yokes attached to an attachment object.

In an embodiment, the first yoke and the second yoke may include a recess with which the fixed permanent magnet is in close contact and a cover portion covering the rotating permanent magnet, wherein the rotating permanent magnet may include a curved portion and a linear portion, and the cover portion may have a curved surface having a radius of curvature greater than a radius of the curved portion of the rotating permanent magnet.

In an embodiment, the radius of curvature of the curved surface of the cover portion may be greater than the radius of the rotating permanent magnet by 0.1 to 0.6 mm, and a center of a radius of the radius of curvature of the curved surface of the cover portion may be the same as a center of the radius of the rotating permanent magnet.

In an embodiment, an additional permanent magnet may be disposed in a position corresponding to that of the fixed permanent magnet or the rotating permanent magnet on an outer surface of each of the first and second yokes.

In an embodiment, a thickness of the additional permanent magnet may be less than a winding thickness of the coil.

In an embodiment, the first and second yokes may include a permanent magnet yoke corresponding to the fixed permanent magnet and the rotating permanent magnet and a coil part yoke including the attachment surface from a portion around which the coil is wound, and the permanent magnet yoke and the coil part yoke may have a separable structure. Here, the coil part yoke may be separated from or mounted on the permanent magnet yoke by a bolt fastened in a direction perpendicular to the attachment surface.

In an embodiment, the magnetic holder may further include a bracket disposed in a position corresponding to both end surfaces of the rotating permanent magnet in the one direction and fixed to the first and second yokes, wherein a shaft may be mounted in the bracket, the rotating permanent magnet may have a recess, and the rotating permanent magnet may be rotatably fixed to the shaft of the bracket.

According to another aspect of the present disclosure, a portable magnetic drill includes: a drill unit; the magnetic holder described above; and a power supply unit providing power to the drill unit and the magnetic holder, wherein the power supply unit includes a rechargeable battery.

### Advantageous Effects

The present disclosure may provide a magnetic holder which may be easily fastened and released and which is easily moved when released, and a magnetic drill including the same.

### DESCRIPTION OF DRAWINGS

FIG. 1 is a schematic diagram of a magnetic drill according to an embodiment of the present disclosure.

FIGS. 2A and 2B are conceptual diagram of a magnetic holder according to an embodiment of the present disclosure.

FIG. 3 is a perspective view of a magnetic holder according to an embodiment of the present disclosure.

FIG. 4 is a cross-sectional view of a magnetic holder according to an embodiment of the present disclosure.

FIG. 5 is a schematic view illustrating formation of a magnetic field in the magnetic holder of FIG. 4.

FIG. 6 is a cross-sectional view of a rotating permanent magnet of a magnetic holder according to an embodiment of the present disclosure.

FIG. 7 is a cross-sectional view of a first yoke of a magnetic holder according to an embodiment of the present disclosure.

FIG. 8 is a cross-sectional view ofa magnetic holder according to an embodiment of the present disclosure.

FIG. 9 is a schematic view illustrating formation of a magnetic field in the magnetic holder of FIG. 8.

FIG. 10 is a cross-sectional view of a magnetic holder according to an embodiment of the present disclosure.

### BEST MODE FOR INVENTION

Hereinafter, a specific embodiment of the present disclosure will be mainly described with reference to the accompanying drawings.

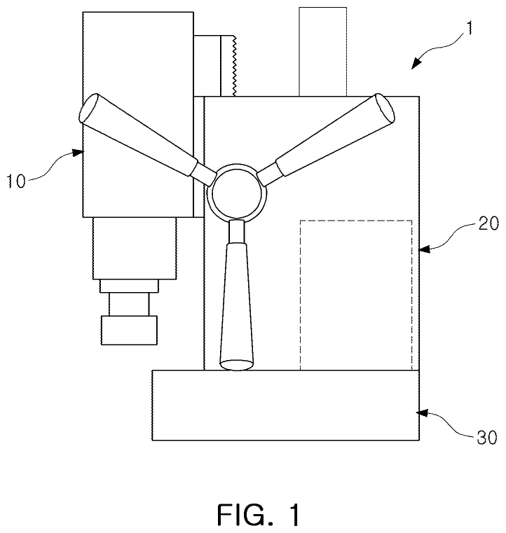

FIG. 1 is a schematic diagram of a magnetic drill according to an embodiment of the present disclosure is shown.

As shown in FIG. 1, a magnetic drill 1 includes a body with a handle; a drill unit 10 connected to one side of the body and including a motor, a gear, etc. for driving the drill; a power supply unit 20 providing power to the drill unit 10; and a magnetic holder 30 for fixing the body to an attachment object.

The drill unit 10 is not different from the related art magnetic drill 1, and thus, a detailed description thereof will be omitted. The power supply unit 20 may include a rechargeable battery.

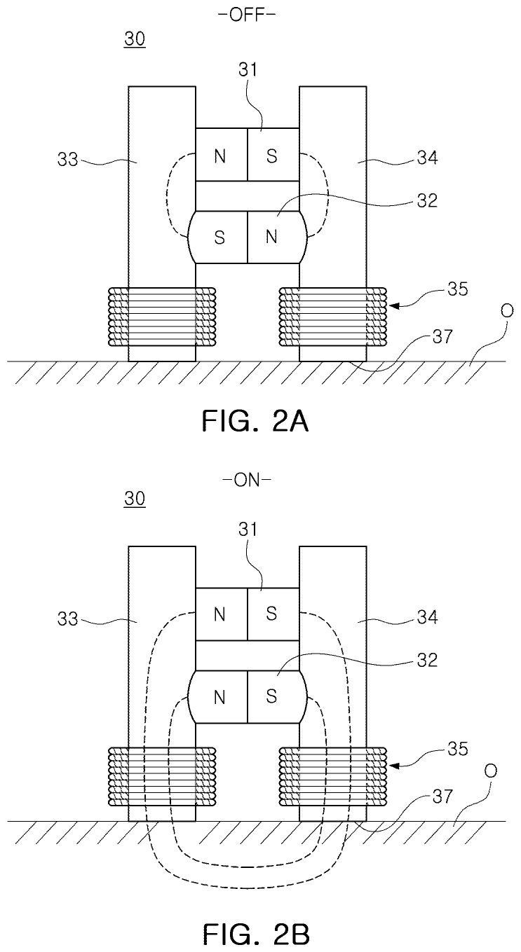

The magnetic holder 30 may include a fixed permanent magnet 31, a rotating permanent magnet 32, and a coil unit 35 (35: see FIG. 2) connected to the power supply unit 20. The magnetic holder 30 may or may not be operated depending on a direction of power supplied to the coil unit 35. The configuration of the magnetic holder 30 will be described in detail again in the description of FIGS. 2 to 10.

In the present embodiment, the magnetic holder 30 is switched between operation/non-operation by means of electricity supply without having to rotate the handle by a user. Therefore, the magnetic holder 30 may be easily operated because it does not require a user's power. In addition, since the magnetic holder 30 is switched between operation/non-operation with an instantaneous current of about 0.3 to 0.5 seconds, power consumption may be reduced, so that the power supply unit 20 having a limited capacity shared by the drill unit 10 and the magnetic holder 30 may be used more for the drill unit 10, which may lead to an increase in the use time until charging.

In addition, since the magnetic holder 30 has a structure that is easy to disassemble and assemble, repairing or assembling is facilitated. In addition, the magnetic holder 30 occupies a small space, allowing the magnetic drill 1 to be compact.

Further, when the magnetic holder 30 does not operate, there is no residual magnetism, so the user may not need an additional force due to a magnetic force in addition to a weight of the magnetic drill 1 or a weight of the attachment object when moving the magnetic drill 1 or when removing the attachment object, which may reduce the user's workload.

FIG. 2 is a conceptual diagram of a magnetic holder 30 according to an embodiment of the present disclosure.

FIG. 2A illustrates a state when the magnetic holder 30 does not operate. The magnetic holder 30 of the present disclosure includes a fixed permanent magnet 31 extending in one direction; a rotating permanent magnet 32 extending in the one direction and rotatably fixed at both ends; first and second yokes 33 and 34 covering both sides of the fixed permanent magnet 31 and the rotating permanent magnet 32 and extending in an up-down direction; and a coil 35 wound around the first and second yokes 33 and 34. In a cross-section perpendicular to the one direction, the first yoke 33 is in contact with an N pole of the fixed permanent magnet 31 and the second yoke 34 is in contact with an S pole of the fixed permanent magnet 31, and the coil 35, the rotating permanent magnet 32, and the fixed permanent magnet 31 are arranged successively along the first and second yokes 33 and 34 from an attachment surface 37 of the first and second yokes 33 and 34 attached to an attachment object O.

As shown in FIG. 2A, when not operated, a magnetic flow is formed on the fixed permanent magnet 31 and the rotating permanent magnet 32 through the first yoke 33 and the second yoke 34. Since no current flows through the coil 35, the rotating permanent magnet 32 is rotated so that the S pole faces the first yoke 33 and the N pole faces the second yoke 34.

In a non-operating state, it is possible to rotate the rotating permanent magnet 32 by applying a current to the coil 35. When a current, sufficiently large for the rotating permanent magnet 32 to be rotated, is applied to the coil such that an upper portion of the coil 35 of the first yoke 33 is S pole and an upper portion of the coil 35 of the second yoke 34 is N pole, the rotating permanent magnet 32 rotates. In this state, when the applied current is cut off, a magnetic flow is formed to pass through the attachment surface 37 as shown in FIG. 2B. N poles of the fixed permanent magnet 31 and the rotating permanent magnet 32 are arranged to face the first yoke 33, and S poles of the fixed permanent magnet 31 and the rotating permanent magnet 32 are arranged to face the second yoke 34.

Since the magnetic holder 1 is sufficient to use power only instantaneously, user convenience may be improved, without putting a burden on the rechargeable battery.

In particular, in the case of the magnetic drill 1, the user may hold, move, and then fix the magnetic drill 1. In the related art, a rotating magnet of a permanent magnet is manually rotated. In the present disclosure, a mechanical structure such as in the related art is used because it is difficult to use an external power source. However, it is effective to instantaneously use power through the coil 35, and it is also useful in that there is no need for a separate user's effort for rotation.

In addition, in order to allow the rotating permanent magnet 34 to rotate smoothly, a radius of curvature of a curved surface formed on the first and second yokes 33 and 34 is greater than a maximum radius of the rotating permanent magnet 32 to form a gap between the rotating permanent magnet 32 and the curved surface. In this case, the gap may act as a resistance element in transmission of magnetic force, the gap may be within a range of 0.1 to 0.6 mm.

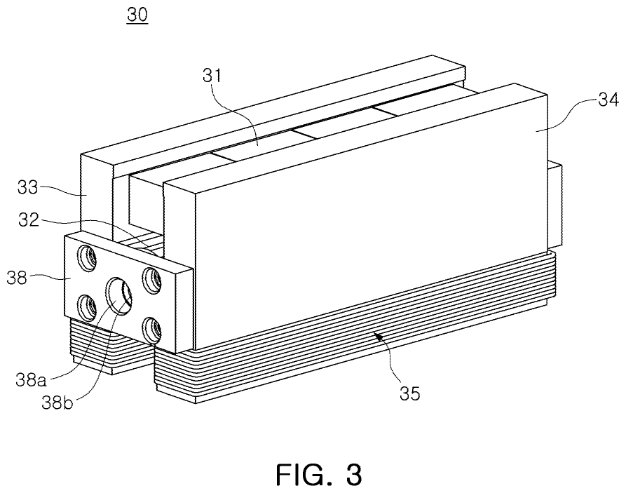

FIG. 3 is a perspective view of the magnetic holder 30 according to an embodiment of the present disclosure.

As shown in FIG. 3, in the magnetic holder 30, the first yoke 33 and the second yoke 34 are arranged on the sides, and a plurality of fixed permanent magnet 31 is arranged to be connected or located as one piece between the first yoke 33 and the second yoke 34 in a longitudinal direction. The rotating permanent magnet 32 is located immediately below the fixed permanent magnet 31. The rotating permanent magnet 32 is formed as one piece.

A bracket 38 for rotatably supporting the rotating permanent magnet 32 is disposed at both ends of the rotating permanent magnet 32 in the longitudinal direction. The bracket 38 is bolted to the first and second yokes 33 and 34 and includes a recess 38a and a bearing 38b located in a position corresponding to a rotating shaft of the rotating permanent magnet 32. The rotating shaft may be inserted into the center of both ends of the rotating permanent magnet 32, and as the rotating shaft is inserted into the bearing 38b, the rotating permanent magnet 32 may be rotated between the first and second yokes 33 and 34. The fixed permanent magnet 31 and the rotating permanent magnet 32 are located adjacent to each other and are positioned close to each other within a limit of not interfering with rotation of the rotating permanent magnet 32.

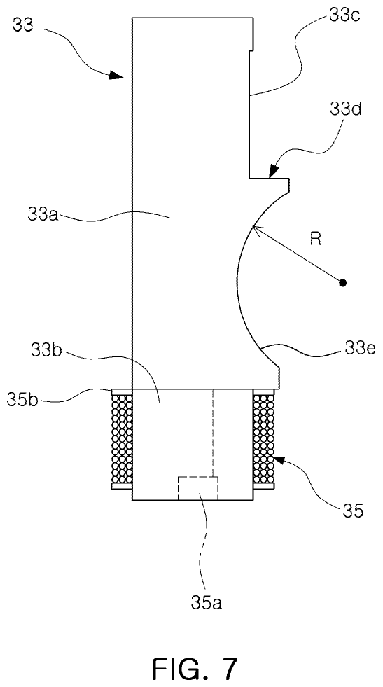

The coil 35 is located below the rotating permanent magnet 32. The first yoke 33 and the second yoke 34 may not be formed as one piece and may be configured to be separated from a portion in which the coil 35 is wound as shown in FIG. 7 (to be described).

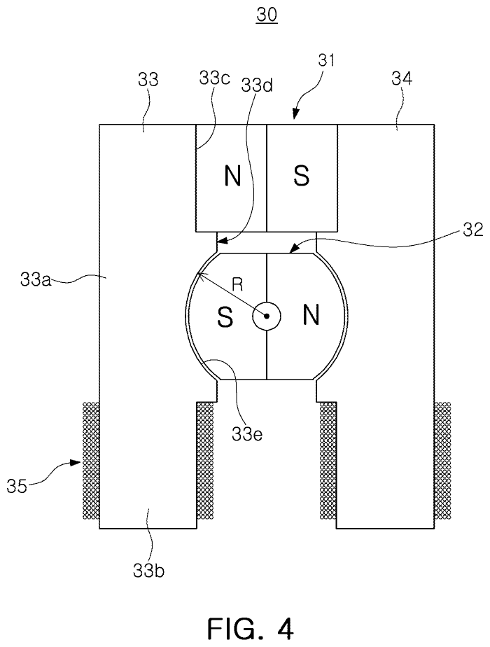

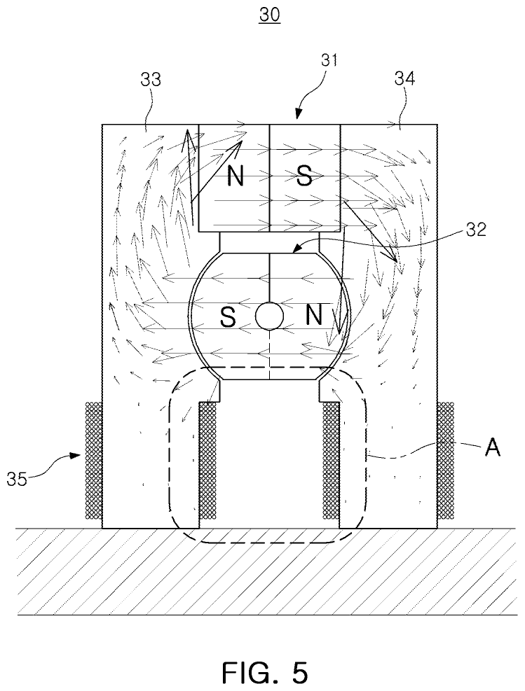

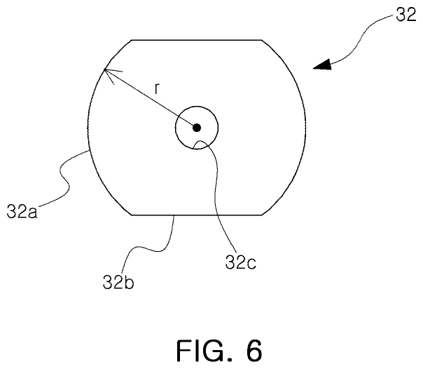

FIG. 4 is a cross-sectional view of a magnetic holder according to an embodiment of the present disclosure, FIG. 5 is a schematic view illustrating formation of a magnetic field in the magnetic holder of FIG. 4, and FIG. 6 is a cross-sectional view of a rotating permanent magnet of a magnetic holder according to an embodiment of the present disclosure.

As shown in FIGS. 4 and 6, the fixed permanent magnet 31 has a rectangular parallelepiped shape, and the rotating permanent magnet 32 includes a pair of curved portions 32a having a certain radius of curvature, a planar portion 32b located between the curved portions 32a, and a rotation recess 32c provided at both ends thereof, into which a rotating shaft is inserted. The rotation recess 32c may be provided at both ends or may be configured as a single recess completely penetrating the rotating permanent magnet 32.

In the first yoke 33, the permanent magnet yoke 33a is formed with a recess 33c into which the fixed permanent magnet is fitted to the surface facing the second yoke 34 and a cover portion 33d covering the curved portion 32a of the rotating permanent magnet 32 therebelow. Upper and lower edges of the cover portion 33d protrude relative to the recess 33c and a central portion thereof is located on an inner side of the recess 33c. In the curve portion 33d, a portion between the upper and lower edges is formed as a curved surface 33e. The curved surface 33e has a radius of curvature R greater than a radius r of the curved portion 32a of the rotating permanent magnet 32, so that the radius of curvature R of the cover portion 33d may be greater than the radius r of the rotating permanent magnet 32 by 0.1 mm to 0.6 mm. The center of the radius r of the rotating permanent magnet 32 and the center of the radius of curvature R of the cover portion 33d are aligned.

As shown in FIG. 5, when the magnetic holder 30 does not operate, a magnetic field formed by the rotating permanent magnet 32 and the fixed permanent magnet 31 rarely flows to an object.

FIG. 7 is a cross-sectional view of the first yoke 33 of the magnetic holder 30 according to an embodiment of the present disclosure.

As shown in FIG. 7, that is, the first yoke 33 includes a permanent magnet yoke 33a and a coil part yoke 33b. The permanent magnet yoke 33a and the coil part yoke 33b have a structure that may be coupled/separated by a bolt 35a, facilitating disassembly and assembly during manufacturing and repair. In particular, in the case of a permanent magnet, there is no room for failure, but in the case of the coil 35, problems such as disconnection may occur depending on use. In the present disclosure, the coil 35 is located at a position adjacent to the attachment surface 37 in the first and second yokes 33 and 34 and a separable structure is applied, thereby improving workability.

As shown in FIG. 7, a guide plate 35b may be disposed on an upper/lower portion of the coil 35 around which the coil 35 is wound in the coil part yoke 33b.

Meanwhile, as shown in a region A of FIG. 5, a partial amount of residual magnetism may be transferred to an attachment target, causing inconvenience in moving the machine after work is finished. In particular, it is very important to further reduce such residual magnetism in devices, for example, magnetic drills that require repeated quick and precise attachment and detachment.

In FIG. 5, since the magnetic holder 30 includes a complicated correlation of the fixed permanent magnet 31, the rotating permanent magnet 32, the first and second yokes 33 and 34, and an airgap between the rotating permanent magnet 32 and the first and second yokes 33 and 34, and the like, it is difficult to analyze how and which components are to be combined to reduce residual magnetism, and thus, it is very difficult to further reduce the residual magnetism.

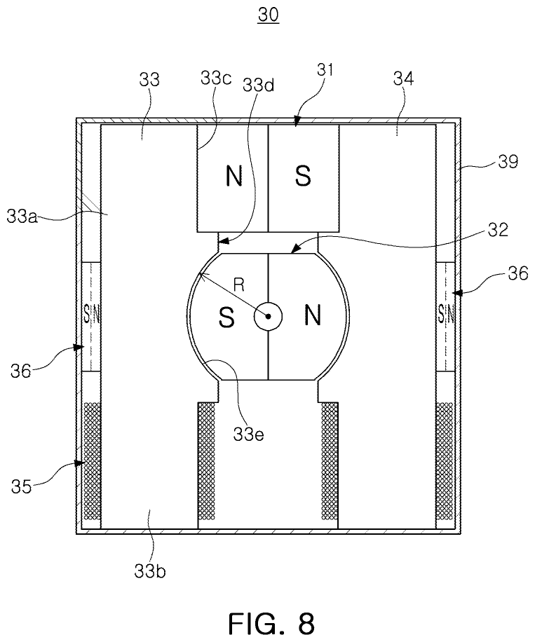

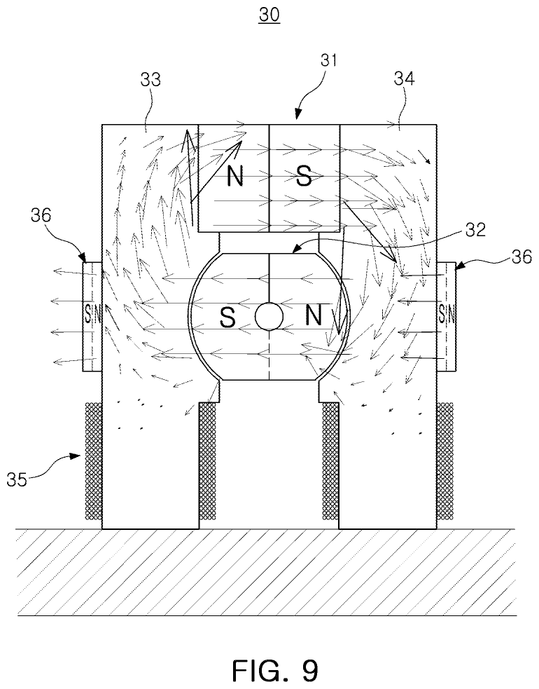

The inventor of the present application devised attachment of an additional permanent magnet to further reduce residual magnetism, and FIGS. 8 and 9 schematically illustrate a cross-sectional view of a magnetic holder and a magnetic field formed in the magnetic holder accordingly.

As shown in FIG. 8, a structure of the fixed permanent magnet 31, the rotating permanent magnet 32, the first yoke 33, the second yoke 34, and the coil 35 in the magnetic holder 30 of FIG. 8 is the same as the structure of the magnetic holder 30 of FIG. 4, and thus, a detailed description thereof will be omitted.

However, in the magnetic holder 30 of FIG. 8, additional permanent magnets 36 are disposed at a height corresponding to the rotating permanent magnet 32 on outer surfaces of the first and second yokes 34, respectively. The additional permanent magnets 36 have a smaller thickness compared to the fixed permanent magnet 31, and each of the additional permanent magnets 36 is disposed such that the same polarities with the fixed permanent magnet 31 face each other in a plan view. That is, the additional permanent magnet 36 is disposed to face a different pole with the rotating permanent magnet 32.

As shown in FIG. 9, due to the additional permanent magnet 36, residual magnetism is not transmitted to an attachment object, and therefore, the user has no difficulty in moving a machine after work is finished, and the additional permanent magnet is more advantageous to a magnetic drill device which requires rapid and precise detachment and attachment.

A thickness of the additional permanent magnet 36 may correspond to a winding thickness of the coil 35 or may be formed to be thinner, and thus, a volume due to the additional permanent magnet 36 may not be increased when the case 39 is provided.

The additional permanent magnet 36 may be attached to the outside the structure of the first and second yokes 33 and 34 of the magnetic holder 30 including the fixed permanent magnet 31, the rotating permanent magnet 32, the first yoke 33, the second yoke 34, and the coil 35, and therefore, it is possible to design to maximize magnetism by the basic structure excluding the additional permanent structure 36 and to remove residual magnetism by the additional permanent magnet 36.

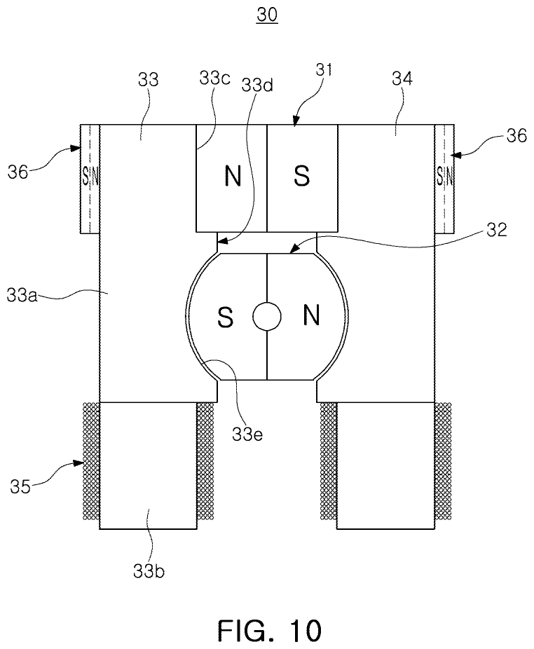

FIG. 10 illustrates a modification of the magnetic holder of the embodiment of FIG. 8. The structure of the fixed permanent magnet 31, the rotating permanent magnet 32, the first yoke 33, the second yoke 34, and the coil 35 as shown in FIG. 10 is the same as the structure of the magnetic holder 30 of FIG. 4.

In FIG. 10, in the first yoke 33 and the second yoke 34, a coil winding portion is configured as a separation type, which is the same as the exemplary embodiment of FIG. 7, and the additional permanent magnet is disposed at a height corresponding to the fixed permanent magnet 31 on outer surfaces of the first and second yokes 34. Similar to the case of FIG. 8, the additional permanent magnet 36 has a small thickness, compared with the fixed permanent magnet 31, and each additional permanent magnet 36 is disposed such that the same polarities face each other with the fixed permanent magnet 31.

Also, FIG. 10 also illustrates the same magnetic flow as that of FIG. 8, so that residual magnetism is not transmitted to an attachment object.

### EXAMPLE 1

Experiment was conducted with the magnetic holder 30 including the first and second yokes 33 and 34 having the same cross-sectional shape as in FIG. 7, the rotating permanent magnet 32 having the same cross-sectional shape as that of FIG. 6 and having a volume of about 43,000 mm³, and the fixed permanent magnet 31 having a volume of about 36,000 mm³. A difference in adsorption force due to the gap between the curved surface 32a of the rotating permanent magnet 32 and the curved surface 33e of the cover portion 33d in the magnetic holder 30 is summarized in Table 1, and a rotation torque, a magnetic force, a torque reduction rate, and a magnetic force reduction rate due to the gap are summarized in Table 2. According to a result of the above experiment, that is, the rotation torque and magnetic force may be changed according to a size/shape of the yoke and permanent magnet to be tested, but the tendency to change the torque reduction rate and the magnetic force reduction rate according to the gap is maintained.

TABLE 1

Adsorption force (N)

| Interval | Active | Inactive |
|---|---|---|
| (mm) | (operation) | (non-operation) |
| 0.1 | 9256 | 38.5 |
| 0.2 | 9150 | 34.8 |
| 0.4 | 9023 | 28.8 |
| 0.6 | 8992 | 23.6 |
| 0.8 | 8785 | 21.0 |
| 1.0 | 8556 | 18.1 |

TABLE 2

| | | Torque rate | | |
|---|---|---|---|---|
| | | (Measurement | | Magnetic force |
| | | rotating | | reduction rate |
| | | torque/rotating | | (Measurement |
| Interval | Torque | torque when | Magnetic | magnetism/magnetism |
| (mm) | (Nm) | internal is 0 mm) | force (N) | when internal is 0 mm) |
| 0 | 45.8 | 1.0 | 9,718 | 1.00 |
| 0.1 | 36.2 | 0.79 | 9,256 | 0.95 |
| 0.2 | 34.8 | 0.76 | 9,150 | 0.94 |
| 0.4 | 33.6 | 0.73 | 9,023 | 0.93 |
| 0.6 | 32.5 | 0.71 | 8,992 | 0.93 |
| 0.8 | 31.3 | 0.68 | 8,785 | 0.90 |
| 1.0 | 30.2 | 0.66 | 8,556 | 0.88 |

As shown in Tables 1 and 2, when the gap is small, the adsorption force is strong, but the torque for the rotation of the rotating permanent magnet 32 increases, so that a large current is required, applying a large load to the power supply unit 30 of the magnetic drill 1, which is, thus, inappropriate. A gap of 0.1 mm or more is preferred for smooth rotation. If the gap exceeds 0.6 mm, the adsorption force during operation was weakened to be insufficient to fix the magnetic drill 1. In the case of the magnetic drill, a compact structure is essential, so there is a limitation in that a large size electromagnetic coil cannot be used to generate excessive rotation torque.

Meanwhile, in the cover portion 33d having the gap of 0.6 mm, with the upper and lower edges protruding from the recess 33c, a magnetic force was 8.992 N, but without the upper and lower edges, the magnetic force was 8.362 N, so the magnetic force of about 7% was reduced in the case in which the edges are not provided.

### EXAMPLE 2

The additional permanent magnet 36 was attached to the magnetic holder 30 including the first and second yokes 33 and 34 having the same cross-sectional shape asthat of FIG. 7, the rotating permanent magnet 32 having the same cross-sectional shape as that of FIG. 6 and having a volume of about 48,000 mm³, and the fixed permanent magnet 31 having a volume of about 44,000 mm³, and experiment was conducted, while changing a thickness of the additional permanent magnet 31. The magnet grades of the fixed permanent magnet 31, the rotating permanent magnet 32, and the additional permanent magnet 36 were the same as Nd50. The additional permanent magnet 36 was 13.5 mm wide and 50 mm long, and two were attached to each side, and the experiment was performed while changing only the thickness.

TABLE 3

| Thickness of | | | | | | |
|---|---|---|---|---|---|---|
| additional magnet | 1 mm | 2 mm | 3 mm | 4 mm | 5 mm | None |
| Residual | 4.2N | 1.5N | 0.95N | 2.66N | 6.45N | 9.15N |
| magnetism | | | | | | |

As can be seen in Table 3, since residual magnetism can be reduced by adjusting the thickness of the additional permanent magnet 36, it may be easy to design the yokes 33 and 34 and the permanent magnets 31 and 32, while manufacturing the magnetic holder 30 in which residual magnetism does not remain.

As can be seen from Table 3, since residual magnetism can be reduced by adjusting the thickness of the additional permanent magnet 36, it is easy to design the yokes 33 and 34 and the permanent magnets 31 and 33, while manufacturing the magnetic holder 30 without residual magnetism. In particular, it is expected to be more advantageous for actual products in that it can cope with changes in magnetic force due to tolerance of manufacturing.

In the above, the embodiments of the present disclosure have been described based on the embodiments of the present disclosure, but the present disclosure is not limited thereto and may be implemented with various modifications.

1. A magnetic holder comprising:
a fixed permanent magnet extending in one direction;
a rotating permanent magnet extending in the one direction and having both ends which are rotatably fixed;
first and second yokes covering both sides of the fixed permanent magnet and the rotating permanent magnet and extending in an up-down direction; and
a coil wound around the first and second yokes,
wherein, in a cross-section, perpendicular to the one direction, the first yoke is in contact with an N pole of the fixed permanent magnet and the second yoke is in contact with an S pole of the fixed permanent magnet, and
the coil, the rotating permanent magnet, and the fixed permanent magnet are arranged successively along the first and second yokes from an attachment surface of the first and second yokes attached to an attachment object.

2. The magnetic holder of claim 1, wherein
the first yoke and the second yoke include a recess with which the fixed permanent magnet is in close contact and a cover portion covering the rotating permanent magnet,
wherein the rotating permanent magnet includes a curved portion and a linear portion, and the cover portion has a curved surface having a radius of curvature greater than a radius of the curved portion of the rotating permanent magnet.

3. The magnetic holder of claim 2, wherein
the radius of curvature of the curved surface of the cover portion is greater than the radius of the rotating permanent magnet by 0.1 to 0.6 mm, and
a center of a radius of the radius of curvature of the curved surface of the cover portion is the same as a center of the radius of the rotating permanent magnet.

4. The magnetic holder of claim 3, wherein,
in a cross-section, perpendicular to the one direction, an edge is formed on upper and lower portions of the curved surface of the cover portion and protrudes relative to the recess.

5. The magnetic holder of claim 1, wherein
an additional permanent magnet is disposed in a position corresponding to that of the fixed permanent magnet or the rotating permanent magnet on an outer surface of each of the first and second yokes.

6. The magnetic holder of claim 5, wherein
a thickness of the additional permanent magnet may be less than a winding thickness of the coil.

7. The magnetic holder of claim 1, wherein
the first and second yokes include a permanent magnet yoke corresponding to the fixed permanent magnet and the rotating permanent magnet and a coil part yoke including the attachment surface from a portion around which the coil is wound, and
the permanent magnet yoke and the coil part yoke have a separable structure.

8. The magnetic holder of claim 7, wherein
the coil part yoke is separated from or mounted on the permanent magnet yoke by a bolt fastened in a direction perpendicular to the attachment surface.

9. The magnetic holder of claim 1, further comprising a bracket disposed in a position corresponding to both end surfaces of the rotating permanent magnet in the one direction and fixed to the first and second yokes,
wherein a shaft is mounted in the bracket, the rotating permanent magnet has a recess, and the rotating permanent magnet is rotatably fixed to the shaft of the bracket.

10. A portable magnetic drill comprising:
a drill unit;
the magnetic holder according to claim 1; and
a power supply unit providing power to the drill unit and the magnetic holder,
wherein the power supply unit includes a rechargeable battery.
